(19) United States
(12) Patent Application Publication
(10) Pub. No.: US 2014/0278728 A1
(43) Pub. Date: Sep. 18, 2014

(54) System and Methods For Determining Risk of Supply Chain Disruption

(71) Applicant: DOE & INGALLS MANAGEMENT, LLC, Durham, NC (US)

(72) Inventors: John David Hollenbach, Raleigh, NC (US); Jerilin Ellen Paith Kenney, Raleigh, NC (US)

(73) Assignee: DOE & INGALLS MANAGEMENT, LLC, Durham, NC (US)

(21) Appl. No.: 13/795,587

(22) Filed: Mar. 12, 2013

(51) Int. Cl. G06Q 10/06

(52) U.S. Cl. CPC G06Q 10/0635
USPC 705/7.28

(57) ABSTRACT

Methods and systems for determining risk in a supply chain and displaying risk to a user. A supply chain is defined in a database by linking one or more driver components to a monitored component. Each driver component is associated with one or more component indicators that provide an indication of an expected availability of the driver component. Each component indicator is assigned a risk score. An expected risk value and a worst case risk value are determined for each component indicator. A risk profile is then determined based on a ratio between the expected risk values of the component indicators and the worst case risk values of the component indicators. The risk profile may then be displayed on a web page through a database portal. If the risk profile exceeds a threshold, the database may transmit a notification to a subscriber to the database.

### FIELD OF THE INVENTION

The present invention relates generally to a system and methods for determining risks to a supply chain and, more particularly, to a system and methods for determining a probability that the supply chain of a monitored product, such as a chemical, may be interrupted.

### BACKGROUND OF THE INVENTION

A supply chain is a system that moves product from a supplier to an end user. Supply chains typically include multiple links. Intermediate links in the supply chain typically receive one or more products from one or more driver links, perform a process on the one or more received products that transforms the one or more received products into another product, and provide this new or transformed product to one or more downstream links. For example, a steel plant may receive iron ore, coke, and limestone from multiple suppliers, and source steel to multiple users downstream. Supply chains thus form a matrix of connected entities that receive materials from one or more sources, process the received materials, and transfer those processed materials to one or more downstream users. This processing may transform the received materials into another product (e.g., a refinery that receives crude oil and produces gasoline, kerosene, asphalt, etc.), or may simply involve receiving the source materials and repackaging and distributing them to one or more users (e.g., a gas station that receives gasoline from the refinery and sells it to individual motorists).

Industries depend on supply chains to provide the source materials they consume, and to distribute the products that are produced from the source materials. If an upstream supplier cannot deliver a source material on which a downstream user depends, the downstream user will either need to find another source for the material, or curtail the amount of product it produces for its downstream users. To mitigate supply chain disruptions, producers may maintain stockpiles of source materials and/or products produced from those source materials. These stockpiles provide insurance against an inability of the suppliers to meet the demand for source materials by allowing the downstream producer to continue to supply product to its customers while another source of materials is identified. Stockpiling also allows suppliers time to correct the cause of a disruption. For example, stockpiling crude oil (the source material) or gasoline (the product) at the refinery may allow the refinery to continue selling gasoline during a disruption to the supply of crude oil.

Although stockpiling materials can be an effective tool for mitigating supply chain disruptions, the recent trend has been to reduce the amount of stockpiling. Reduced stockpiles tie up less capital, require less storage space, and reduce the risk to the stockpiling producer that they will be forced to write down the cost of the stockpiled materials in the event demand for their product is unexpectedly reduced. However, reducing or eliminating stockpiles also increase the risk that supply chain disruptions will cause the producer to incur economic losses due to an inability to meet the demand for their products. Therefore, the amount of materials stockpiled is typically determined based at least in part on the risk that a supply chain will be disrupted to balance the costs of maintaining the stockpile against the risk of economic loss due to a supply chain disruption.

Thus, there is a need for improved systems and methods for managing supply chains that determines the risk that a supply chain disruption will be disrupted.

### SUMMARY OF THE INVENTION

The present invention overcomes the foregoing problems and other shortcomings, drawbacks, and challenges of mitigating the effects of supply chain disruptions. While the present invention will be described in connection with certain embodiments, it will be understood that the present invention is not limited to these embodiments. To the contrary, the present invention includes all alternatives, modifications, and equivalents as may be included within the spirit and scope of the present invention.

In an embodiment of the present invention, a computer implemented method is provided for determining and displaying a risk of disruption to a supply chain. The method includes defining the supply chain in a database by linking one or more driver components to a monitored component, each driver component being associated with one or more component indicators. The method further includes determining a risk profile value for the supply chain based on the component indicators associated with the one or more driver components, associating the risk profile value with the supply chain in the database, and displaying the supply chain and the risk profile value for the supply chain.

In another embodiment of the present invention, a computer implemented method is provided for determining and displaying a risk of disruption to one or more supply chains. The method includes defining a plurality of supply chains for a monitored component in a database by linking one or more driver components in each supply chain to the monitored component, each driver component being associated with one or more component indicators. The method further includes associating a first monitored component identifier with a first supply chain of the plurality of supply chains and a second monitored component identifier with the second supply chain of the plurality of supply chains, displaying the first supply chain in response to the first monitored component identifier being activated, and displaying the second supply chain in response to the second monitored component identifier being activated.

In yet another embodiment of the present invention, a system for determining and displaying a risk of disruption to a supply chain is presented. The system includes a processor and a memory that stores instructions which, when executed by the processor, cause the processor to define the supply chain in a database by linking one or more driver components to a monitored component, each driver component being associated with one or more component indicators. The instructions further cause the processor to determine a risk profile value for the supply chain based on the component indicators associated with the one or more driver components, associate the risk profile value with the supply chain in the database, and display the supply chain and the risk profile value for the supply chain.

In yet another embodiment of the invention, a computer program product is presented. The computer program product includes a non-transitory computer readable storage medium storing instructions that, when executed by a processor, cause the processor to define the supply chain in a database by linking one or more driver components to a monitored component, each driver component being associated with one or more component indicators. The program instructions further cause the processor to determine a risk profile value for the supply chain based on the component indicators associated with the one or more driver components, associate the risk profile value with the supply chain in the database, and display the supply chain and the risk profile value for the supply chain.

### BRIEF DESCRIPTION OF THE DRAWINGS

The accompanying drawings, which are incorporated in and constitute a part of this specification, illustrate embodiments of the present invention and, together with a general description of the present invention given above, and the detailed description of the present invention given below, serve to explain the principles of the present invention.

FIG. 1 is a schematic block diagram illustrating an exemplary operating environment for a risk management system that includes a plurality of computer systems in communication via a network in accordance with an embodiment of the present invention.

FIG. 2 is a schematic block diagram illustrating an exemplary computer system of FIG. 1 in accordance with an embodiment of the present invention.

FIG. 3 is a diagrammatic view of a supply chain process map in accordance with an embodiment of the present invention.

FIG. 4 is a schematic block diagram that depicts a process for determining an overall risk profile for the supply chain process map of FIG. 3 in accordance with an embodiment of the present invention.

FIG. 5 is a diagrammatic view of a web page that provides user access to a database portal in accordance with an embodiment of the present invention.

FIG. 6 is a diagrammatic view of a welcome page of the database portal in accordance with an embodiment of the present invention.

FIG. 7 is a diagrammatic view of an account information page of the database portal in accordance with an embodiment of the present invention.

FIG. 8 is a diagrammatic view of a market intelligence page of the database portal in accordance with an embodiment of the present invention.

FIGS. 9 and 10 are diagrammatic views depicting a market drivers window of the market intelligence page of FIG. 8.

FIG. 11 is diagrammatic view of a producer information window of the market intelligence page of FIG. 8.

FIG. 12 is diagrammatic view of a production process window of the market intelligence page of FIG. 8.

FIG. 13A is diagrammatic view of a supply chain window of the market intelligence page of FIG. 8 that includes supplier windows for one supply chain for a material.

FIG. 13B is diagrammatic view of the supply chain window of the market intelligence page of FIG. 8 that includes supplier windows for another supply chain for the material.

FIG. 14 is diagrammatic view of data entry window for entering data into one of the supplier windows of the supply chain window of FIG. 13A.

FIG. 15 is diagrammatic view of a confirmation window displayed in response to submitting the data entry window of FIG. 14.

FIG. 16 is a diagrammatic view of an update notification window displayed in response to confirming the data in the confirmation window of FIG. 15.

FIG. 17 is a diagrammatic view of change log window that provides a record of changes to the supply chain of FIG. 13A.

### DETAILED DESCRIPTION OF THE PREFERRED EMBODIMENT

Embodiments of the present invention provide a system and methods for determining a risk of supply chain disruption. To this end, embodiments of the present invention monitor the potential risks associated with an interruption of a supply chain for upstream and downstream materials associated with a monitored product. This monitoring is based on a repeatable and systematic process that includes a proprietary database which provides market intelligence, chemical process maps, and component indicators for monitored products. The database further provides a custom statistical analysis and weighted risk probabilities for each supply chain component. The process consists of three main steps that proactively identify and quickly mitigate supply chain risks. The first step involves mapping the underlying chemical processes and suppliers that comprise the supply chain to attain a full understanding of supply chain. Based on the mapped supply chain, embodiments of the present invention monitor on a continual basis market drivers that could impact the supply chain, and provide system users with risk assessment data. This risk assessment data facilitates mitigating identified risks by informing customers through Management of Risk (MOR) notices, which may provide recommend solutions and keep system users abreast of any potential supply chain interruptions.

Referring now to FIG. 1, and in accordance with an embodiment of the present invention, a supply chain risk management system 10 may include a risk management server 12, a subscriber system 14, one or more information resources 15, a Management of Risk (MOR) database 16, and a portal application 17 in communication via a network 18. The risk management server 12, subscriber system 14, information resources 15, MOR database 16, and portal application 17 may each be provided by or hosted on a computing system. Exemplary computing systems include, but are not limited to, cloud computers, desktop computers, laptop computers, portable computers and devices, tablet and touch pad computers and devices, handheld computers and devices, network devices, mobile phones, smart phones, servers, or any other device suitable for receiving and processing data. The network 18 may include one or more local access networks (LANs), wireless networks (private or commercial), and/or publically accessible networks, such as the Internet, that communicatively couple the components of the risk management system 10.

Although depicted as separate system resources for the sake of clarity, persons having skill in the art will understand that all or portions of the MOR database 16 and portal application 17 may be at times resident on the risk management server 14, the subscriber system 15, and/or provided as a service by the network 18 (e.g., hosted by “the cloud”). Embodiments of the present invention are therefore not limited to the configuration of the risk management system 10 shown in FIG. 1.

Referring now to FIG. 2, an exemplary computing system 20 suitable for hosting the risk management server 12, the subscriber system 14, the one or more information resources 15, the MOR database 16, and the portal application 17 includes a processor 22, a memory 24, a network interface 26, a user interface 28, and a mass storage device 30. The processor 22 may include one or more processors selected from microprocessors, micro-controllers, digital signal processors, microcomputers, central processing units, field programmable gate arrays, programmable logic devices, state machines, logic circuits, and/or any other devices that manipulate signals (analog and/or digital) based on operational instructions that are stored in memory 24. Memory 24 is operatively coupled to the processor 22, and may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, and/or any other device capable of storing data.

Processor 22 may operate under the control of an operating system 32 that resides in memory 24. When present, the operating system 32 manages the computing system 20 resources so that program code embodied as one or more applications 34 residing in memory 24 may have instructions executed by the processor 22. In an alternative embodiment, the application 34 may be executed by the processor 22 directly, in which case the operating system 32 may be omitted. The network interface 26 of computing system 20 may include suitable radio transceiver circuitry configured to support a wireless link to the network 18. In any case, the application 34 may include program code that, when read and executed by the processor 22, causes the computing system 20 to perform the steps necessary to execute steps, elements, methods, modules, processes and/or functional blocks embodying the various aspects and embodiments of the present invention.

The network interface 26 provides a communication link between the processor 22 and the network 18 so that data may be exchanged between the processor 22 and other computer resources coupled to the network 18, such as the risk management server 12, the subscriber system 14, the information resources 15, the MOR database 16, and the portal application 17. To this end, the network interface 26 may connect to the network 18 via suitable network communication protocol, such as Transmission Control Protocol/Internet Protocol (TCP/IP) over Ethernet, or the IEEE 802.11 protocol (Wi-Fi) over a wireless link.

The user interface 28 is operatively coupled to the processor 22 of computing system 20, and includes at least one output device and one input device. Suitable output devices for the computing system 20 include, but are not limited to, a touch screen, an alphanumeric display, an audio transducer, and/or any other visual, audible, and/or tactile indicator. Likewise, suitable input and/or control devices include, but are not limited to, the aforementioned touch screen, an alphanumeric keyboard or keypad, a pointing device, pushbuttons, a microphone, and/or any other device capable of accepting commands or input from the user and transmitting the entered input to the processor 22. The user interface 28 thereby provides a mechanism whereby a user may input data to, and receive data from, the processor 22.

The computing system 20 may also include mass storage device 30. The mass storage device 30 may comprise a single mass storage device or a plurality of mass storage devices including but not limited to hard drives, optical drives, tape drives, non-volatile solid state devices and/or any other device capable of storing digital data. A database 36 residing in memory 24 or the mass storage device 30 (shown) may provide the MOR database 16 described above with respect to FIG. 1. To this end, the database 36 may include data regarding supply chain risks and components so as to provide a searchable database that receives data from, and provides data to, one or more applications 34. Although shown as a single database 36, database 36 may include multiple databases 36 configured to support various system functions. Examples of databases 36 that may be supported by computing system 20 include one or more databases including data regarding market intelligence, chemical process maps, market indicators of interest, and custom statistical analysis and weighted probabilities for each component indicator measure.

Although illustrated as a single computing system in FIG. 2 for the sake of clarity, it should be understood that the computing system 20 may include a plurality of hardware platforms and/or a plurality of software programs. Moreover, various program code described herein may be identified based upon the application or software component within which it is implemented in a specific embodiment of the present invention. However, it should be appreciated that any particular program nomenclature used herein is merely for convenience, and thus the present invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the present invention is not limited to the specific organization and allocation of program functionality described herein.

Thus, persons skilled in the art will recognize that the exemplary operational environment illustrated in FIGS. 1 and 2 is not intended to limit the present invention. Embodiments of the present invention may therefore include alternative hardware and/or software environments, and incorporate different numbers and configurations of hardware and software resources without departing from the scope of the present invention. For example, risk management server 12, subscriber system 14, the information resources 15, the MOR database 16, and/or the portal application 17 may be embodied as one or more network services that provide one or all of the above described components and/or functions of the computer system 20 in the form of a cloud computing system.

Referring now to FIGS. 3 and 4, in an embodiment of the present invention, the first step in determining the risk of a supply chain disruption may be to map a production process for each product (e.g., a chemical) being monitored by generating a process map. The process map illustrates relationships between upstream and downstream drivers for the chemical being monitored. The process map thereby facilitates assessing the components of the manufacturing process, and evaluating the impact each driver component may have on the availability of the product being produced. The factors assessed may include: (1) general market availability and intelligence of the components or suppliers, (2) supply and demand dynamics of the component by industry and application, and (3) special quality concerns needed in the component to make the quality of raw material used in the targeted industry.

In FIG. 3, an exemplary process map 40 is provided that presents a visual representation of the relationship between associated supply chain driver components 42-48 involved in the supply of a product represented by a monitored component 50 (e.g., ammonium sulfate ([NH₄]₂SO₄)). FIG. 4 illustrates the product supply chain driver components 42-48 in more detail. Each supply chain driver component 42-48 includes one or more component indicators 54 that is associated with a risk score 56, a component weight 58, and a probability of impact 60. The process map 40 may include supply chain driver components 42-48 that represent multiple sources of the chemical product. For example, in the illustrated embodiment, one source of ammonium sulfate 50 is direct synthesis by combining sulfuric acid 44 and anhydrous ammonia 46 in a reactor. Another source of ammonium sulfate is the ammonium sulfate produced as a byproduct of caprolactam ([CH₂]₅COHN) production, which is represented by supply chain driver component 47. Because the majority of the caprolactam produced is normally used to manufacture nylon 6, the production of nylon 6 may also be included in the production process map as a supply chain driver component 48 due to the effect production of nylon-6 has on the demand for production of caprolactam.

The supply of directly synthesized ammonium sulfate 50 is monitored using the refined crude oil supply chain driver component 42, the sulfur supply chain driver component 43, the sulfuric acid supply chain driver component 44, the natural gas supply chain driver component 45, and the ammonia supply chain driver component 46. Refined crude oil may be supplied from a plurality of sources 62, which may be collectively accounted for in the refined crude oil supply chain driver component 42. Similarly, natural gas may be supplied from a plurality of sources 63 that are collectively accounted for in the natural gas supply chain driver component 45.

The refined crude oil risk supply chain driver component 42 may also include more than one component indicator 54. For example, refined crude oil risk supply chain driver component 42 may include a rig count component indicator 54 and refined crude oil point price in Chinese Yuan component indicator 54. Oil rig counts may provide a leading indicator for an expected level of crude oil production, with rising rig counts indicating increased levels of production, and dropping rig counts indicating that production is falling. The oil point price, in turn, may provide an indicator of the world demand for refined crude oil. Because sulfur is produced as a by-product of oil refining, the amount of oil being refined, as indicated by the crude oil supply chain driver component 42, may provide a risk level associated with the supply of sulfur 43. Examples of component indicators include: a price of the supply chain component (e.g., the crude oil spot price in Cushing, Okla.), a process by which the supply chain component is produced (e.g., fracking for natural gas), and market indicators for the supply chain component (e.g., rig count, futures prices, production level of a product that consumes the supply chain component).

The risk score 56 may be a subjective measure of market information interpretation that is associated with each component indicator 54. The risk score 56 may thereby provide an indication of the perceived risk associated with the component indicator 54. In one embodiment of the present invention, the risk score 56 may be between 1 and 5, with a value of 1 indicating that the perceived risk is low, and a value of 5 indicating the perceived risk is high. In the exemplary supply chain driver component 42 for refined crude oil described above, the rig count indicator may have an assigned a risk score of 1, indicating that the perceived risk of changes in the rig count indicator is relatively low. In contrast, the point price in Chinese Yuan may have an assigned a risk score of 3, indicating a moderate risk of significant price fluctuations.

The component weight 58 associated with each component indicator 54 may be a subjective measure of the influence the component indicator 54 has on its associated product. In an exemplary embodiment of the present invention, the component weight scores may range from 1 to 5, with the component weight for the rig count market indicator being 2 and the component weight of the point price in Chinese Yuan being 1. A level of 2 may indicate that the rig count has a low-to-moderate influence on the amount of oil refining. A level of 1 may indicate that the point price in Chinese Yuan has a low influence on the amount of crude oil refining. A level of 5, on the other hand, may indicate a strong correlation between the market indicator 54 and the activity supplying the downstream component. That is, if the component weight of rig count component indicator was 5, the amount of oil being refined would be strongly correlated to the rig count component indicator.

The probability of impact 60 may be a subjective measure of the relevance of quality, availability, and economics of the component indicator on the product. The higher the expected impact of the component indicator 54 on the supply of the downstream component, the higher the probability of impact. In an embodiment of the present invention, the probability of impact values may be selectable from 0 to 100. A value of 100 may indicate that a disruption in the supply of the upstream component has a 100% chance of impacting the supply of the downstream component, while a value of 0 may indicate that a disruption of the upstream component has a 0% chance of impacting the supply of the downstream component. An exemplary value for the probability of impact 60 associated with the rig count and point price of refined crude oil may be 33, indicating that a variance in the rig count and/or point price of refined crude oil in Yuan each has a 33% chance of impacting the supply of sulfur.

An expected risk value 64 for each of the component indicators 54 is determined by taking the product of the risk score 56, component weight 58, and probability of impact 60. Using the exemplary values provided above for rig count (risk score=1, component weight=2, probability of impact=33) and price point of refined crude oil in Chinese Yuan (risk score=3, component weight=1, probability of impact=99) the expected indicator risk factor value 64 for the rig count would be 1×2×33=66, and the expected indicator risk factor value 64 for the point price of refined crude oil in Chinese Yuan would be 3×1×33=99.

A worst case risk value 66 is then calculated by setting the value of the risk score 56 to 5 and recalculating the product of the risk score 56, component weight 58, and probability of impact 60. Performing this calculation with the above exemplary values results in a worst case risk value of 330 for the rig count, and 165 for the point price of refined crude oil in Chinese Yuan. Expected and worst case risk values 64, 66 are calculated for each risk factor component 52 associated with the process map 40. Table I provides an exemplary list of supply chain driver components 42-48, their associated component indicators 54, and exemplary values for the risk scores 56, component weights 58, probabilities of impact 60, expected risk values 64 and worst case risk values 66 for each component indicator 54.

TABLE I
RISK PROFILE CALCULATION

| | Component | Risk | | Probability | | |
|---|---|---|---|---|---|---|
| Component | Indicator | Score | Component | of Impact | Expected Risk | Worst Case |
| (42-48) | (52) | (56) | Weight (58) | (60) | (64) | Risk (66) |
| Ammonia | Fracking | 1 | 1 | 33 | 33 | 165 |
| (46) | | | | | | |
| Ammonia | PP | 4 | 1 | 33 | 132 | 165 |
| (46) | Ammonia | | | | | |
| Natural Gas | PP Nat Gas | 1 | 1 | 33 | 33 | 165 |
| (45) | Price | | | | | |
| Sulfuric Acid | PP Crude | 1 | 1 | 33 | 33 | 165 |
| (44) | Oil Price | | | | | |
| Sulfuric Acid | PP Zinc | 1 | 1 | 33 | 33 | 165 |
| (44) | | | | | | |
| Sulfur (43) | PP Sulfur | 3 | 1 | 33 | 99 | 165 |
| | Price | | | | | |
| Crude Oil | Rig Count | 1 | 2 | 33 | 66 | 330 |
| (42) | | | | | | |
| Crude Oil | PP Chinese | 3 | 1 | 33 | 99 | 165 |
| (42) | Yuan | | | | | |

| | | |
|---|---|---|
| Total Risk | 528 | 1485 |

To define a risk profile 76 for the monitored component 50 (e.g., ammonium sulfate 50), the expected indicator risks 64 are summed 68 to produce a total expected risk score, or “total expected risk” 70, and the worst case risk values 66 summed 72 to produce a “total worst case risk” 74. The ratio of the total expected risk 70 and total worst case risk 74 is then calculated to produce the risk profile 76, which may have a value that ranges from 0 to 1. In an embodiment of the present invention, the risk profile 76 may be associated with a color that is displayed to the system user, with the color depending on the value of the risk profile 76. For example, a risk profile 76 having a value of 0.00 to 0.19 may be associated with the color green, indicating a neutral or low risk. Similarly, a risk profile of 0.20 to 0.39 may be associated with the color light green, a risk profile of 0.40 to 0.59 may be associated with the color yellow, (indicating a medium risk), a risk profile of 0.60 to 0.79 may be associated with the color orange, and a risk profile of 0.80 to 1.00 may be associated with the color red (indicating a critical or high risk). The risk profile 76 may be recalculated each time new data is received or inputted into the system. For example, if a new risk score 56 is received for the rig count component indicator 54, the risk profiles 76 may be recalculated for each product map 40 that includes the rig count component indicator 52 in one of the associated supply chain components.

The risk management system 10 thereby enables supply chain risks associated with a plurality of chemical products to be monitored by entering data and information obtained through the mapping and monitoring processes into the MOR database 16. The resulting MOR database 16 may be a custom designed database that captures: (1) a specific manufacturing process for each chemical or material being monitored; (2) the component indicators 54 that are linked to each of the product supply chain driver components 42-48 associated with the manufacturing process of the monitored component 50; and (3) the risk scores 56, weights 58, and probabilities of impact 60 for each component indicator associated with the supply chain process map 40. Database users may thereby build process maps 40 for a plurality of monitored components 50 by defining connections, or links between product supply chain driver components 42-48. Data, such as values of the component indicators 54, may be entered by system users, or may be receive directly from information resources 15 through the network 18.

Access to the resulting MOR database 16 may be restricted to the system operator so that only authorized users can update the database 16. However, the content of the database 16 may be provided to subscribing users through a web-based portal provided by the portal application 17, referred to herein as the MOR portal. In an embodiment of the present invention, the MOR portal may be accessed via a suitable client application running on the subscriber system 14, such a web browser. The subscriber may thereby log into a web server application hosted by, for example, the risk management server 12, to access the MOR portal.

Referring now to FIG. 5, and in accordance with an embodiment of the present invention, an exemplary home page 80 may include one or more images 82, a news and events window 84 that displays text and images that the site operator wishes to share with users, a navigation bar 86 having a plurality of navigation buttons 88 the activation of which takes the user to a new page, a search term field 90, and a portal access button 92. The home page 80 may thereby provide an entry point for subscribing users to access the MOR portal that is remotely accessible by the user.

In response to the user activating the portal button 92, the portal application 17 may prompt the user to enter login information, such as a user name and password. The login prompt may be in the form of fields supplied in a pop-up window or login page, for example. In response to the user entering the login information, the portal application 17 may display a welcome page 100, an example of which is illustrated in FIG. 6. The welcome page 100 may include the navigation bar 86, navigation buttons 88, and search term field 90 from the home page 80, and may further include a portal navigation window 102, a risk level summary window 104, and a MOR portal logout button 106. The portal menu 102 may include navigation buttons that allow the user to cause the portal to selectively display pages containing information of interest to the user.

For example, the portal menu 102 may include a “my materials” button 108 that takes the user to a page where they can select which products to monitor, a “MOR resources” button 110 that takes the user to a resources page, an “announcements” button 112 that takes the user to an announcement page, a “supply chain button” 113 that takes the user to a supply chain page, a “MOR notices” button 114 that takes the user to page which displays MOR database notices, a “change notifications” button 116 that takes the user to a change notifications page, a “contact us” button 118 that takes the user to a page configured to allow the user to send messages to the system operator, and an “account information” button 120 that takes the user to an account settings page.

The risk level summary window 104 may include a plurality of monitored product windows 122. Each monitored product window 122 may include an overall risk level indicator 124, a product identifier field 126 that includes the name of the monitored product (e.g., ammonium sulfate), a risk change alert notification selection box 128, and a monthly statement selection box 130. The alert notification selection box 128 may allow user to indicate a desire to receive alerts based on a change in the value of a risk profile 76 for the monitored product identified in the product identifier field 126. These alerts may be in the form of an e-mail, a text message, automated phone call, or any other suitable form of communication that may be sent to an electronic address provided by the user in response to the value of the risk profile 76 passing a threshold. This threshold may coincide with the boundaries between the risk profile value ranges represented by the indicator colors (as described above with respect to FIGS. 3 and 4), or may be selected by the user. Similarly, the user may indicate a desire to receive monthly summaries or reports concerning the supply chain risks associated with the monitored product identified in the product identifier field 126 by checking the monthly statement selection box 130. These summaries may be provided to the user in any suitable manner, such as in an e-mail or as a hard copy sent to the user's street address.

The overall risk level indicator 124 may have a color corresponding to the value of the risk profile 76 of the underlying product. For example, in an embodiment of the present invention, and as described above, the risk level indicator may be green, light green, yellow, orange, or red depending on the value of the risk profile 76 associated with the corresponding monitored component 50. The overall risk indicator 124 may thereby provide the user with a quick indication of which monitored products currently have a low risk of disruption (e.g., are colored green), and which products have a high risk of disruption (e.g., are orange or red). The color identification of risk profiles values may thereby allow the user to quickly determine which monitored products should be reviewed in more detail.

Referring now to FIG. 7, in response to activating the account information button 120, the portal may display an account information page 140. The account information may include the navigation bar 86, navigation buttons 88, and search term field 90, the portal navigation window 102, and an account information window 142. The account information window 142 may include a company identifier window 144, one or more contact information windows 146, and an add contact button 148. The company identifier window 144 may include fields that display a name and address of the company that owns the MOR portal account. The contact information window 146 may include, for example, fields that display the name, title, e-mail address, phone number, and geographic address of a contact within the company identified in window 144. To add an additional contact to the company subscription, an authorized user may activate the add contact button 148.

Referring now to FIG. 8, and with continued reference to FIG. 6, in response to the user activating the “my materials” button 108, the portal application may display a materials drop down menu 150 in the portal navigation window 102. The drop down menu 150 may include a plurality of buttons 152a-152g, with each button 152a-152g corresponding to one of the monitored products listed in the risk level summary window 104. In response to activating one of the buttons 152a-152g, the portal application 17 may display a market intelligence page 160 for the monitored product that includes a “snapshot” button 162, a “market drivers” button 164, a “producers” button 166, a “processes” button 168, and a “supply chain” button 169.

In response to activation of the snapshot button 162, the portal application may display a snapshot window 170 on the market intelligence page 160. The snapshot window 170 may include the overall risk level indicator 124, a product summary window 172 that provides a short description of the monitored product and/or its uses, a graph 174 showing the historical price of the monitored product, and a risk profile summary window 176 that provides information regarding the current risk profile, such as the risk levels and recent prices for upstream materials used to manufacture the monitored product.

Referring now to FIGS. 9 and 10, in response to activation of the market drivers button 164, the portal application 17 may display a market drivers window 180 that displays information about upstream and downstream drivers for the monitored product in question. An upstream driver is a material or process that has an impact on the sources of the monitored product. For example, an upstream driver may be a process or material that: (1) is used for the production of the monitored product, or (2) that produces the monitored product as a byproduct. In contrast, a downstream driver is a material or process that has an impact on consumption of the monitored product. The upstream and downstream driver information may be in the form of graphs and textual descriptions, and provides subscribers with market intelligence that helps identify risks to the supply chain for the monitored product.

In the illustrated example, the market drivers window 180 includes a market drivers summary window 182, a selected drivers window 184 that provides information regarding the relevance of the market drivers and why they were selected, upstream driver graphs 186, 188, 190, and a downstream driver graph 192. The market drivers summary window 182 may include a market driver risk indicator 194 and a text window 196 that provides additional information regarding the current market driver risk indicator value. The market driver risk indicator 194 may provide a risk profile value associated with just the displayed market drivers. In all other ways, the market driver risk indicator 194 may be similar to the overall risk level indicator 124. That is, the market drive risk indicator 194 may be color coded and have a value determined by the ratio of the total expected risk and total worst case risk for the market drivers displayed in the selected drivers window 184.

The upstream driver graphs in the illustrated embodiment include graphs that provide historical prices of sulfuric acid 186 (which is used in the synthesis of ammonium sulfate), caprolactam 188, (the production of which produces ammonium sulfate) and nylon-6 190 (the production of which consumes caprolactam). The downstream driver graph 192 is a bar graph illustrating the price of fertilizers, the production of which consumes ammonium sulfate. The graphs 186, 188, 190, 192 may also include textual information 198, 200, 202, 204 regarding the material represented by the corresponding graph. Examples of information include whether the current price is within normal fluctuations, the current risk level for the graphed material, recent changes in price and reasons for the change, or any other information deemed useful to the subscriber by the portal operator.

Referring now to FIG. 11, in response to activation of the producers button 166, the portal application 17 may display a producer information window 210 that includes a producer risk level indicator 212, a producer listing window 214, and a production distribution graph 216 (shown as a pie chart). The producer risk indicator 212 may provide a risk profile value associated with just the displayed producers of the monitored product. In all other ways, the producer risk indicator 212 may be similar to the overall risk level indicator 124 and the market driver risk indicator 194. That is, the producer risk indicator 212 may be color coded and have a value determined by the ratio of the total expected risk and total worst case risk for the displayed producers.

The manufacturer listing window 214 may provide a list of the major global or domestic producers of the monitored product. The production distribution graph 216 may provide a breakdown of the percentages of total production by each producer. By way of example, the manufacturing listing window 214 may list the top producers of Ammonium Sulfate as company A, company B, and company C. The production distribution graph 216 might indicate that company A produces 20 percent of the total supply of ammonium sulfate, company B produces 10 percent of the total supply of ammonium sulfate, and company C produces 10 percent of the total supply of ammonium sulfate. The remaining 60 percent of ammonium sulfate production may be produced by smaller suppliers and listed as “other” in the graph 216.

Referring now to FIG. 12, in response to activation of the processes button 168, the portal application may display a production process window 220. The production process window 220 may provide a graphical representation 222 of all or a portion of the process map 40 depicted in FIG. 3. The production process button 168 thus provides a view of the manufacturing process for the monitored product. In the exemplary embodiment illustrated in FIG. 12, a production level of sulfur as a byproduct of crude oil refining is represented by block 224. The sulfur output of block 224 thereby adds to a supply of sulfur, which is represented by block 226. The supply of sulfur 226 is used to produce sulfuric acid, so that a supply of sulfuric acid represented by block 228 is dependent, at least in part, on the supply of sulfur 226.

Similarly, a supply of natural gas 230 is tapped to produce ammonia, which is added to a supply of ammonia that is represented by block 232. The supply of ammonia 232 is used in combination with the supply of sulfuric acid 228 to produce ammonium sulfate, the supply of which is represented by block 234. Significant amounts of ammonium sulfate are also added to the supply of ammonium sulfate 234 as a byproduct of polymer production 236. Specifically, ammonium sulfate is produced as a byproduct during the manufacture of caprolactum, which is used to make nylon-6. The graphical representation may also depict consumers of the supply of ammonium sulfate 234, such as production of fertilizer, which is represented by block 238. The graphical representation 222 thereby provides a visual aid that may help users understand the dependent relationships between the monitored product and the indicators used to determine the risk of a disruption to the supply of the monitored product.

Building a supply chain specific to a particular portal subscriber may be a collaborative effort by the subscriber and the operator of the MOR database 16. To provide this feature, the portal application 17 may be configured to allow the system subscriber and system operator to enter supplier data into the MOR database 16 so that the MOR database 16 includes information specific to that subscriber. The MOR database 16 and portal application 17 may be further configured so that access to subscriber specific information is restricted to a particular subscriber or group of subscribers. Information may also be entered that is generally available to all subscribers. Portions of the database 16 may also be viewable by non-subscribers visiting the home page 80 to, for example, generate interest in subscribing to the portal. The MOR database 16 may thereby be configured to store all suppliers that contribute to the supply chain of a product for display by the portal application 17. In addition, supply chain details may be identified by, or linked to a unique monitored component identifier, such as a stock keeping unit (SKU). In an embodiment of the present invention, a specific product SKU may be selected by the subscriber so that the supply chain for the specific product may be quickly located in the MOR database 16 based on the SKU.

Referring now to FIGS. 13A and 13B, in response to activating the supply chain button 169, the portal application 17 may display a supply chain window 240. The supply chain window 240 may be configured to allow a system user to define one or more supply chains in the MOR database 16 for each tracked material 152a-152g by adding upstream and downstream components (i.e., driver components), and defining links between these components using an object-oriented editor. To this end, the supply chain window 240 may include windows 242a-245a, 242b-245b representing upstream and downstream components of a supply chain 250a, 250b, and a toolbox 252 that provides additional tools for editing and viewing the selected supply chain 250a, 250b. These windows 242a-245a, 242b-245b may in turn be linked by lines depicting dependencies between supply chain components. In the exemplary embodiment illustrated in FIGS. 13A and 13B, two supply chains 250a, 250b for ammonium sulfate are shown, with each supply chain identified by a corresponding SKU number 253, 255.

The SKU numbers may represent generally available products (e.g., catalog numbers) that identify supply chains that are visible to multiple users, or may be specific to a particular user or set of users. An SKU that is specific to a particular user may identify a supply chain that is only viewable by that user, or a supply chain that contains information regarding drivers in the supply chain that is not widely known. The SKU numbers displayed to the user may therefore depend on the identity of the user. Moreover, the level of information displayed to the user selecting a particular SKU may depend on the identity of the user, with some users being provided a higher level of supply chain information than other users. That is, some users may have access to more detailed supply chain information for a supply chain identified by a specific SKU than other users activating the same SKU.

The windows 242a-245a, 242b-245b of each supply chain 250a, 250b may be connected by links that define the relationships between components of the supply chain 250a, 250b. Each window 242a-245a, 242b-245b may include an edit button 246a-249a, 246b-246b that allows the user to enter information related to the supply chain component represented by the corresponding window 242a-245a, 242b-245b. The toolbox 252 may include a button 254 for adding components or links to the selected supply chain 250a, 250b, and a button 256 that allows the user to zoom in and out on the displayed supply chain 250a, 250b.

In the exemplary embodiment illustrated by FIG. 13A, in the supply chain 250a includes 4 driver components. Window 242a represents a manufacturer (company “DEF”) of ammonium sulfate, window 243a represents a repackager (company “ABC”) of ammonium sulfate, window 244a represents a non-specific supplier of sulfuric acid, and window 245a represents a non-specific supplier of ammonia. In the exemplary embodiment, the suppliers of sulfuric acid and ammonia are shown as unknown. This may be due to an unwillingness of the manufacturer represented by window 242a to reveal their sources of materials. In cases where supply chain drivers are not specifically known, risks may be assessed based on a risk to the overall supply of the material in question, for example. In any case, the windows representing the suppliers of sulfuric acid 244a and ammonia 245a are linked to the manufacturer window 242a to define dependencies by the manufacturer on the supplies of sulfuric acid and ammonia. The repackager window 243a is similarly linked to the manufacturer window 242a to define a dependency by the repackager on the manufacturer for the repackager's supply of ammonium sulfate.

Referring now to FIG. 13B, the user may cause the supply chain 250b to be displayed by activating the corresponding SKU number 255. Similarly to FIG. 13A, in supply chain 250b, window 242b represents a manufacturer (e.g., company “XYZ”) of ammonium sulfate, window 243b represents a repackager (e.g., company “RST”) of ammonium sulfate, window 244b represents a supplier of sulfuric acid (in this case, a known company “OPQ”), and window 245b represents a supplier of ammonia (in this case, a known company “JKL”). As with supply chain 250a, the windows representing the suppliers of sulfuric acid 244b and ammonia 245b are linked to the manufacturer window 242b to define dependencies by the manufacturer on the supplies of sulfuric acid and ammonia. The repackager window 243b is similarly linked to the manufacturer window 242b to define a dependency by the repackager on the manufacturer for the repackager's supply of ammonium sulfate.

Supply chains may be completely independent or may share some dependencies. That is, in some cases, suppliers will have a common link, and in other cases, suppliers will not have a common link. Completely independent supply chains do not share any common links or drivers, so an event that disrupts a driver of one supply chain will not affect the other supply chain. Disruptions to completely independent supply chains will thus be uncorrelated. Two supply chains may also share one or more drivers, so that a disruption to the shared drivers will affect both supply chains. That is, disruptions between the supply chains sharing a driver component may have some level of correlation, with the level of correlation increasing as the number of shared drivers increases. Likewise, supply chains having driver components that share the same component indicator (e.g., the price of crude oil) may have risk profile values movements that are correlated due to the common component indicator (e.g., a rise in the price of oil moves both risk profile values in the same direction). By displaying a graphical representation of the supply chains 250a, 250b, embodiments of the invention may facilitate identifying common drivers across a plurality of supply chains. This may allow users to select suppliers having supply chains with fewer common links, thereby increasing the user's confidence that the risk of a supply disruption is being reduced by adding an additional supplier.

In the exemplary embodiment, the supply chains 250a, 250b have independent manufactures 242a, 242b and repackagers 243a, 243b, so events affecting one of these drivers (e.g., an explosion at a plant of company ABC) will not affect the other supply chain. However, the independence of the suppliers of sulfuric acid and ammonium is uncertain because the manufacturers represented by windows 244a and 245a could be the same as those in windows 244b and 245b.

Thus, one benefit of mapping each supply chain for a material having multiple supply chains is that it allows system users to identify common suppliers or commodity sources in the supply chain. By identifying common drivers in the supply chains for two different SKU's, system users may be able to determine a level of correlation between risk indicators for different supply chains. This may help determine inherent risks in the supply of a material associated with a given SKU. This practice highlights any overlapping points in the supply chain and allows users to elevate the potential risk assessment where there are common drivers, shared resources, or other similarities. Based on the insights provided by mapping the supply chains 250a, 250b, the present invention may be able to make recommendations to add new or different sources that have unrelated links in the supply chain. By selecting supply chains having reduced correlation levels, system users may be able to reduced correlation between sources and reduce the overall risk of a disruption to their supply of a material.

Referring now to FIG. 14, in response to activating the edit supplier button 247 of repackager window 243, the portal application 17 may cause a supply chain data entry window 260 to be displayed to the system user. The data entry window 260 may include a product information window 261, a relationship window 264, a supplier information window 266, a verification status window 268, and a submit information button 270. Each of these windows 261, 264, 266, 268 may be populated with data currently stored in the MOR database 16 that corresponds to the supply chain component window being edited. In the event that a newly created component window is being edited, the windows 261, 264, 266, 268 may be devoid of data.

The product information window 261 may include a supplier product number data entry field 262 and a supplier product name data entry field 273 configured to accept data from the system user regarding the product number and product name, respectively. The relationship window 264 may include an upstream checkbox 272, a downstream checkbox 274, and a product selection field 276. Placing a cursor in the product selection field 276 or activating a product selection button 275 may activate a drop-down menu (not shown) that allows the system user to select from a plurality of products entered into the MOR database 16. The system user may then activate one of the upstream or downstream checkboxes 272, 274 to indicate whether the product in the product selection field 276 is upstream or downstream of the product identified in the product information window 262. The relationship window 264 is thereby configured to enable the system user to define a relationship between two products in the supply chain window 240.

The supplier information window 266 may include data entry fields for a location of the specific plant where activities occur that are associated with the product identified in the product information window, and the type of activities the supplier performs (e.g., manufacturing, repackaging, distribution, refining, etc.). The supplier information window 266 may also include data entry fields for a primary contact for the supplier. The verification status window 268 may include checkboxes that allow the system user to classify the data entered into the data entry window 260. In an embodiment of the present invention, the system user may classify the information as verified by activating checkbox 277, as speculative by activating checkbox 278, and as confidential by activating checkbox 279. Data classified as confidential may be restricted so that the data can only be viewed by authorized system users (e.g., only employees of the subscribing company or persons identified as having access by the system operator). Data that is considered verified may include supplier information vetted by: (1) determining where the supplier obtains their raw materials, (2) evaluating the suppliers procurement process, and (3) identifying common links that the supplier shares with other suppliers in the database, to name but a few of the criteria that may be evaluated. When the system user has finished entering data into the data entry window 260, the system user may submit the data to the MOR database 16 by activating the submit information button 270.

Referring now to FIG. 15, in response to the system user activating the submit information button 270, the portal application 17 may display a confirmation window 280. The confirmation window 280 may include: (1) a supplier information window 282 that displays the data relating to the name and location of the supplier entered into the supplier information window 266 of data entry window 260; (2) a product information window 284 that displays the data entered into the product information window 261 of data entry window 260; (3) a relationship window 285 that displays the data entered into the relationship window 264 of data entry window 260; (4) a type of supplier window 286 that displays the data entered into the supplier information window 266 of data entry window 260 regarding the type of activities the supplier performs; and (5) a main contact window 288 that displays main contact data entered into the supplier information window 266 of data entry window 260.

If the system user discovers an error in the data displayed in the confirmation window 280, the user may indicate that the data is in error by activating a “NO” button 290, which may return the user to the data entry window 260. If the system user is satisfied that the data displayed in the confirmation window 280 is accurate, the user may activate the “YES” button 292.

Referring now to FIG. 16, in response to activation of the “YES” button 292, the portal application 17 may display an update notification window 300. The update notification window 300 may include text informing the system user that the MOR database 16 has been updated with the date entered into the data entry window 260. The text may include a link 302 that takes the user to a change log page, and a link 304 that takes the user back to the supply chain window 240.

Referring now to FIG. 17, in response to activating the change log link 302, the portal application 17 may display a change log window 310. The change log window 310 may include entries 312, 314 that provide information regarding additions, subtractions, and changes to suppliers in the MOR database 16. Each entry 312, 314 may include a date field 316, 318 that provides a time the change was made, and a change type field 320, 322 that describes the change. The change log window 310 may thereby provide the system user with a log of all the changes that have been made to the supply chain 250.

Once the supply chain 250 is defined, component indicators 54 for each component of supply chain 250 are linked to their corresponding supplier. The risk profile 76 is then determined for the supply chain 250 as described above with respect to FIG. 4 so that the component indicators 54 may be monitored for changes based on the risk profile 76.

The risk management system 10 may rely on a broad mix of information resources to assess changes to component indicators 54. These resources may include: (1) internal dashboards created to track specific commodity data points, updated with information from resources such as ICIS, commodity chemical reports, government indices and news; (2) news alerts from basic producers; and (3) a network of suppliers and customers who share market intelligence. The data obtained from these resources may be entered into the system by the system operator so that data can be vetted prior to being entered into the database. In some cases, data may be received by the database directly from an information resource 15. Component indicator values may thereby be updated automatically or in response to the system operator confirming an update from the information resource 15.

When a risk is identified and a risk level is changed for a market indicator, the MOR database 16 produces a prioritized list of potentially impacted products. The list will then be evaluated by an internal chemical market analyst to determine potential impact. The system operator may verify the information through a network of contacts and decide if customers need to be notified of potential risks identified in the supply chain.

In addition to monitoring market indicators, the system operator may work with suppliers and producers who influence the supply chain of each product in the MOR database 16. To this end, the system operator may monitor a macro supply chain (e.g., common suppliers who have at least some control over the market supply of the target product) and a micro supply channel (e.g., specific suppliers producing/supplying the targeted product). As with the component indicators 54, the system operator may monitor producer/supplier risk factors by identifying top suppliers of key raw materials in the United States and world-wide. These suppliers may be monitored for key risk factors such as: (1) core manufacturing competency (basic manufacturer, reprocessing, repackaging); (2) facility geographic location(s) (weather/transportation monitoring); (3) labor force (union vs. non-union); (4) open access information (e.g., publicly available market data) and limited access information (e.g., privately available financials, business risks, etc.); (5) core market focus—what markets do the supplier's products primarily service, is there profitability in the market focus, is it valued in the industry; and (6) supplier quality controls. Once a risk is identified, a notification process may initiated to inform customers to prepare for supply chain disruptions so that any supply chain disruptions may be mitigated.

While the present invention has been illustrated by the description of embodiments thereof, and while these embodiments have been described in considerable detail, it is not the intention of the applicant to restrict or in any way limit the scope of the appended claims to such detail. Additional advantages and modifications will readily appear to those skilled in the art. Therefore, the present invention in its broader aspects is not limited to the specific details of the representative apparatus and method, and illustrative examples shown and described. Accordingly, departures may be made from such details without departing from the spirit or scope of applicants' general inventive concept.

What is claimed is:

1. A computer implemented method for determining and displaying a risk of disruption to a supply chain, the method comprising:
defining the supply chain in a database by linking one or more driver components to a monitored component, each driver component being associated with one or more component indicators;
determining a risk profile value for the supply chain based on the component indicators associated with the one or more driver components;
associating the risk profile value with the supply chain in the database; and
displaying the supply chain and the risk profile value for the supply chain.

2. The method of claim 1 further comprising:
monitoring the risk profile value; and
in response to the risk profile value exceeding a threshold, notifying the system subscriber.

3. The method of claim 2 wherein monitoring the risk profile value includes:
updating at least one component indicator of the one or more component indicators in the supply chain;
determining an updated risk profile value for the supply chain based on the component indicators associated with the one or more driver components; and
comparing the updated risk profile value with the threshold.

4. The method of claim 2 wherein notifying the system subscriber includes automatically sending a message to an electronic address associated with the subscriber.

5. The method of claim 1 further comprising:
defining each of the component indicators by assigning a risk score to the component indicator, the value of the assigned risk score being between a minimum risk score value and a maximum risk score value.

6. The method of claim 5 further comprising:
determining an expected risk value for each component indicator based on the assigned risk score value of the component indicator; and
determining a worst case risk value for each component indicator based on what the risk value for the component indicator would be if the risk score value was set to the maximum risk score value.

7. The method of claim 6 further comprising:
assigning a component weight value and a probability of impact value to each component indicator,
the expected risk value for each component indicator being determined by taking the product of the assigned risk score value, the assigned component weight value, and the assigned probability of impact value, and
the worst case risk value for each component indicator being determined by taking the product of the maximum risk score value, the assigned component weight value, and the assigned probability of impact value.

8. The method of claim 7 further comprising:
summing the expected risk values for the component indicators;
summing the worst case risk values for the component indicators; and
determining a risk profile value for the supply chain by taking a ratio of the sum of expected risk values and the sum of the worst case risk values.

9. The method of claim 6 further comprising:
selecting a portion of the one or more driver components in the supply chain;
summing the expected risk values for the component indicators associated with the portion of the one or more driver components;
summing the worst case risk values for the component indicators associated with the portion of the one or more driver components; and
determining a risk profile value for the portion of the one or more driver components by taking a ratio of the sum of expected risk values and the sum of the worst case risk values.

10. The method of claim 1 wherein the one or more driver components includes an upstream component and a downstream component.

11. The method of claim 1 further comprising:
displaying a risk level indicator on a web page, the risk level indicator providing an indication of the risk profile value for the supply chain.

12. The method of claim 11 further comprising:
assigning a color to the risk profile value based on the value of the risk profile value; and
displaying the color in at least a portion of the risk level indicator.

13. The method of claim 11 further comprising:
displaying a button on the web page; and
in response to activation of the button, displaying a graph indicating historic values of one of the one or more component indicators.

14. The method of claim 11 further comprising:
displaying a portal navigation window on the web page, the portal navigation window including a first plurality of buttons, each button configured to cause the web page to display data associated with the supply chain in response to being activated.

15. The method of claim 14 wherein the database includes a plurality of supply chains, the method further comprising:
in response to activation of one of the first plurality of buttons in the portal navigation window, displaying a drop down menu, the drop down menu including a second plurality of buttons, each of the second plurality of buttons being associated with a monitored component of a supply chain of the plurality of supply chains; and
in response to activation of one of the second plurality of buttons, displaying a market intelligence web page for the monitored component associated with the one of the second plurality of buttons.

16. A computer implemented method for determining and displaying a risk of disruption to a plurality of supply chains, the method comprising:
defining a plurality of supply chains for a monitored component in a database by linking one or more driver components in each supply chain to the monitored component, each driver component being associated with one or more component indicators;
associating a first monitored component identifier with a first supply chain of the plurality of supply chains and a second monitored component identifier with the second supply chain of the plurality of supply chains;
displaying the first supply chain in response to the first monitored component identifier being activated; and
displaying the second supply chain in response to the second monitored component identifier being activated.

17. The method of claim 16 further comprising:
determining a risk profile value for the first supply chain based on the one or more component indicators associated with the one or more driver components of the first supply chain;
determining a risk profile value for the second supply chain based on the one or more component indicators associated with the one or more driver components of the second supply chain; and
associating the risk profile values for the first and second supply chains with their respective first and second supply chains in the database, wherein
displaying the first and second supply chains includes displaying the associated risk profile value for the displayed supply chain.

18. The method of claim 16 wherein the one or more driver components of the first supply chain include at least one driver component not included in the second supply chain.

19. The method of claim 16 further comprising:
associating the first monitored component identifier with a first user; and
associating the second monitored component identifier with a second user different than the first user, wherein
the first monitored component identifier is activatable by the first user but not the second user, and the second monitored component identifier is activatable by the second user but not the first user.

20. The method of claim 16 further comprising:
associating the first monitored component identifier with a first user; and
associating the second monitored component identifier with a second user different than the first user, wherein
the first monitored component identifier is activatable by the first user but not the second user, and the second monitored component identifier is activatable by both the first user and the second user.

21. The method of claim 16 wherein displaying the first supply chain in response to the first monitored component identifier being activated includes:
displaying a first level of supply chain information for the first supply chain to a user with a first user identity; and
displaying a second level of supply chain information for the first supply chain to a user with a second user identity, the second level of supply chain information including information not included in the first level of supply chain information.

22. The method of claim 16 wherein displaying the first and second supply chains includes displaying a plurality of linked windows, each window representing a driver of the displayed supply chain.

23. A system for determining and displaying a risk of disruption to a supply chain, the system comprising:
a processor; and
a memory, the memory storing instructions that, when executed by the processor, cause the processor to:
define the supply chain in a database by linking one or more driver components to a monitored component, each driver component being associated with one or more component indicators;
determine a risk profile value for the supply chain based on the component indicators associated with the one or more driver components;
associate the risk profile value with the supply chain in the database; and
display the supply chain and the risk profile value for the supply chain.

24. A computer program product comprising:
a non-transitory computer readable storage medium; and
program instructions stored on the computer readable storage medium that, when executed by a processor, cause the processor to:
define the supply chain in a database by linking one or more driver components to a monitored component, each driver component being associated with one or more component indicators;
determine a risk profile value for the supply chain based on the component indicators associated with the one or more driver components;
associate the risk profile value with the supply chain in the database; and
display the supply chain and the risk profile value for the supply chain.
